(19) United States
(12) Patent Application Publication
(10) Pub. No.: US 2006/0031572 A1
(43) Pub. Date: Feb. 9, 2006

(54) Event broker

(75) Inventors: Yehuda Feuerstein, Redmond, WA (US); Robert S. Wigton, Redmond, WA (US)

Correspondence Address: BANNER & WITCOFF LTD.,;ATTORNEYS FOR MICROSOFT, 1001 G STREET , N.W., Suite 1100, WASHINGTON, DC, 20001-4597, US

(73) Assignee: Microsoft Corporation, Redmond, WA (US)

(21) Appl. No.: 10/848,417

(22) Filed: May 18, 2004

(51) Int. Cl. G06F 15/173

(52) U.S. Cl. 709/238

(57) ABSTRACT

The invention provides for in-process and inter-process event notification in a distributed computing environment. The event notification system and method utilizes a hierarchical namespace to determine events of interest to registered subscribers. If an event falls within the hierarchical namespace of a registered subscriber, the event is received in the subscriber's queue. The use of a hierarchical namespace enables a subscriber to process events intended for the subscriber even though additional events are presented to the subscriber.

### FIELD OF THE INVENTION

Aspects of the present invention generally relate to systems and methods of reporting events in a computer system across a distributed computing environment. More specifically, aspects of the invention provide for in-process and inter-process event notification for client server applications in a distributed computing environment.

### BACKGROUND OF THE INVENTION

In a distributed computer environment such as the Internet, client machines and servers may be located at different locations. In such environments, applications tend to be distributed between client and server machines. As these systems become more componentized their complexity increases making it even more important that these components, regardless of their location, be able to efficiently communicate with each other.

In such distributed and componentized systems, notifying an application of changes that an application program may be interested in presents a difficult problem. For instance, an application program may be interested in knowing about events such as any account balance changes to a particular user checking account. In order to accomplish these notifications, the application program may utilize message oriented middleware such as publisher subscriber programs to provide event notification services.

In these publisher subscriber application programs, a subscriber subscribes to receive certain events from a publisher of those events. A queue is used to receive the notifications of the particular events from the publisher and deliver those notifications to the subscriber. In these traditional publisher subscriber programs, a flat namespace is used in order to determine which subscribers have registered to receive which events. Using these traditional publisher subscriber programs requires working with, tracking, and managing numerous queues as each subscriber has to subscribe to a unique set of queues which is redundant and inefficient. In addition, when publishers and subscribers need to work with queues they must work with each queue separately.

Therefore, there is a need in the art for an improved system and method for event notification that may be utilized in a client server architecture which supports both in-process and inter-process event notification. The notification system should provide an inter communication channel which would enable components to communicate with each other whether they reside in the same process, in separate processes or across a distributed computer environment such as the Internet. In addition, the event notification system should provide a single unified interface regardless of the location of the components.

### BRIEF SUMMARY OF THE INVENTION

The inventive method and system of the present invention overcomes the problems described above by providing for in-process and inter-process event notification for client server applications in a distributed computing environment using a hierarchical namespace. If the events fall within a hierarchical namespace registered by a subscriber, the events are placed in the subscriber's queue. The use of a hierarchical namespace enables a subscriber to forgo processing of events not intended for the subscriber even though additional events which are both intended for processing by the subscriber and not intended for processing by the subscriber are presented to the subscriber.

The event notification system provides an inter communication channel which enables components to communicate with each other whether they reside in the same process, in separate processes or across a distributed computer environment such as the Internet. The invention may also provide a single unified interface regardless of the location of the components.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example of a suitable computing system environment on which the invention may be implemented;

FIG. 2 shows a schematic diagram of an in-process event notification system in accordance with an aspect of the present invention;

FIG. 3 shows a schematic diagram of an inter-process event notification system in accordance with an aspect of the present invention;

FIG. 4 shows a schematic diagram for a distributed event notification system in accordance with an aspect of the present invention; and

FIG. 5 shows a second schematic diagram for a distributed event notification system in accordance with another aspect of the present invention.

### DETAILED DESCRIPTION OF THE INVENTION

In order to clarify the disclosure of the invention, definitions of several relevant terms are provided herein.

Sink: an object for receiving notifications about events for a certain event queue.

Source: an object for transmitting events into event queues. The source object is a counter part of the sink object.

Subscriber: process or application code that opens a sink on some event queue.

Provider: process or application code that opens a source for some event queue.

Exemplary Operating Environment

Aspects of the invention are suitable for use in a variety of distributed computing system environments. In distributed computing environments, tasks may be performed by remote computer devices that are linked through communications networks. Embodiments of the present invention may comprise special purpose and/or general purpose computer devices that each may include standard computer hardware such as a central processing unit (CPU) or other processing means for executing computer executable instructions, computer readable media for storing executable instructions, a display or other output means for displaying or outputting information, a keyboard or other input means for inputting information, and so forth. Examples of suitable computer devices include hand-held devices, multiprocessor systems, microprocessor-based or programmable consumer electronics, network PCS, minicomputers, mainframe computers, and the like.

The invention will be described in the general context of computer-executable instructions, such as program modules, that are executed by a personal computer or a server. Generally, program modules include routines, programs, objects, components, data structures, etc., that perform particular tasks or implement particular abstract data types. Typically the functionality of the program modules may be combined or distributed as desired in various environments.

Embodiments within the scope of the present invention also include computer readable media having executable instructions. Such computer readable media can be any available media, which can be accessed by a general purpose or special purpose computer. By way of example, and not limitation, such computer readable media can comprise RAM, ROM, EEPROM, CD-ROM or other optical disk storage, magnetic disk storage or other magnetic storage devices, or any other medium which can be used to store the desired executable instructions and which can be accessed by a general purpose or special purpose computer. Combinations of the above should also be included within the scope of computer readable media. Executable instructions comprise, for example, instructions and data which cause a general purpose computer, special purpose computer, or special purpose processing device to perform a certain function or group of functions.

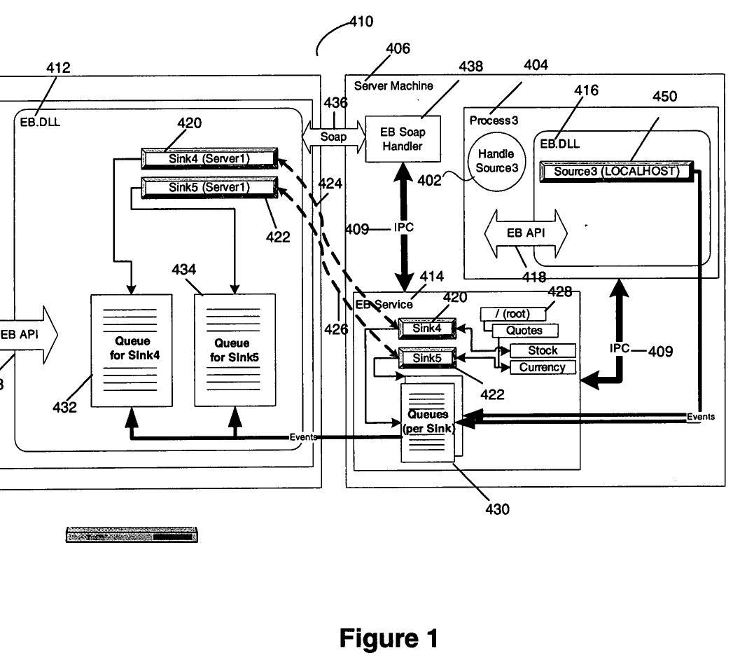

FIG. 1 illustrates an example of a suitable distributed computing system 100 operating environment in which the invention may be implemented. Distributed computing system 100 is only one example of a suitable operating environment and is not intended to suggest any limitation as to the scope of use or functionality of the invention. System 100 is shown as including a communications network 102. The specific network implementation used can be comprised of, for example, any type of local area network (LAN) and associated LAN topologies and protocols; simple point-to-point networks (such as direct modem-to-modem connection); and wide area network (WAN) implementations, including public Internets and commercial based network services. Systems may also include more than one communication network, such as a LAN coupled to the Internet

Computer device 104, computer device 106, and computer device 108 may be coupled to communications network 102 through communication devices. Network interfaces or adapters may be used to connect computer devices 104, 106, and 108 to a LAN. When communications network 102 includes a WAN, modems or other means for establishing communications over WANs may be utilized. Computer devices 104, 106 and 108 may communicate with one another via communication network 102 in ways that are well known in the art. The existence of any of various well-known protocols, such as TCP/IP, Ethernet, FTP, HTTP and the like, is presumed.

Computers devices 104, 106 and 108 may exchange content, applications, messages and other objects via communications network 102. In some aspects of the invention, computer device 108 may be implemented with a server computer or server farm. Computer device 108 may also be configured to provide services to computer devices 104 and 106. Alternatively, computing devices 104, 106, and 108 may also be arranged in a peer-to-peer arrangement in which, for a given operation, ad-hoc relationships among the computing devices may be formed.

### Description of Illustrative Embodiment

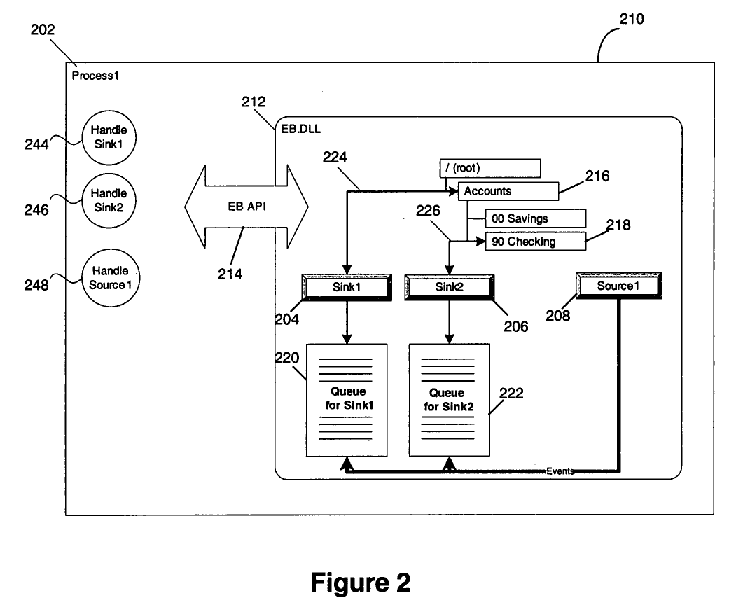

FIG. 2 illustrates a schematic diagram of an in-process event notification system in accordance with an aspect of the present invention. Such an event notification system may be located on one or more computing devices, such as the computing devices shown in FIG. 1. In FIG. 2, Process1 202 has registered within its domain sink1 object 204 and sink2 object 206. Sink1 object 204 and sink2 object 206 may be registered to receive particular events of interest. The events or event objects (not shown) may comprise an extendable container that carries the event payload data from the source objects to the sink objects. The event payload data may include an event name, an event type, a sourceobjID for the source object that injected the event, and a time stamp of when the event was injected.

Process1 202 may register within its domain source1 object 208. Sink1 object 204, sink2 object 206, and source1 object 208 may communicate through an inter-component communication channel 210 which may be called an Event Broker for the purpose of describing the present invention. The Event Broker 210 may enable components such as sink1 object 204, sink2 object 206, and source1 object 208 to interact with each other whether the components reside in the same process such as Process1 202 or in separate processes. In addition, Event Broker 210 may also enable components to communicate with each other over a distributed environment such as the Internet.

Referring to FIG. 2, Process1 202 may communicate with EB.dll 212 through an application programming interface EB API 214. EB.dll 212 may manage in-process event queues and may act as a proxy for out of process event queues. Objects such as sink1 object 244, sink2 object 246, and source1 object 248 may be handles used to identify objects within EB.dll 212 during communication through EB API 214.

EB API 214 may provide a single unified interface regardless of the location of the components. In addition, EB API 214 may include at least four sets of functions such as EB source functions, EB sink functions, EB general functions, and EB transaction functions. These functions may operate on a source object, a sink object, or an event.

Source1 object 208 may inject events into the publish-subscribe communication system of the present invention. The events injected by source1 object 208 may be identified by a hierarchical naming convention called a hierarchical namespace. The hierarchical namespace may comprise a hierarchy representing a geographical, logical, or physical organization of objects. An example of a hierarchical namespace is illustrated below in the context of a power plant. Those skilled in the art will realize that numerous illustrations may have been utilized to illustrate a hierarchical namespace and the use of the following power plant example is not intended to be limiting.

In a power plant, suppose there are hundreds of subsystems, thousands of components, and millions of subcomponents that may generate events. In addition, there may be hundreds of entities that need to be notified of these events. Some subscribers of events may only care about a particular subsystem. For instance, electricians may only be concerned with events for which they may have responsibility, such as events concerning electrical systems or generation equipment such as generators. Electricians may subscribe to events that are named “/PSE/PowerPlants/Plant5/Turbines/Generators/G8.” The events that are named “/PSE/PowerPlants/Plant5/Turbines/Generators/G8” may comprise the particular output reading of a generator identified as generator G8. The output readings of generator G8 may include power output in megawatts or stator temperature reading from thermocouples in degrees Celsius. Electricians subscribed to “/PSE/PowerPlants/Plant5/Turbines/Generators/G8” may receive all events pertaining to generator G8.

Other subscribers of events may be interested in all events concerning plant number 5. Events concerning plant number 5 may be named “/PSE/PowerPlants/Plant5.” These events may include all events for plant number 5 including the events named for generator G8, as Plant5 is the parent class of generator G8. Similarly, generator G8 is a subclass of the parent class Generators. A subscriber of events of “/PSE/PowerPlants/Plant5” may receive events concerning turbines, generators, and generator G8 as “/PSE/PowerPlants/Plant5” is the parent structure of “/PSE/PowerPlants/Plant5/Turbines/Generators/G8.”

As one skilled in the art will realize, the root of the hierarchy tree is represented by the string “/”. Each level of the hierarchy may be separated by a forward slash character similar to a file path in an operating system.

Returning to FIG. 2, sink1 object 204 may be interested in events that relate to Accounts 216. Furthermore, sink2 object 206 may be interested in events concerning only a particular account such as 90 Checking 218. When source1 object 208 injects an event such as “/Account/90 Checking/Details/Friendly Name,” the event is in-scope for both sink1 object 204 and sink2 object 206. Eb.dll 212 may decide which sinks such as sink1 object 204 or sink2 object 206 want to receive the events. EB.dll 212 may manage in-process event queues for both sink1 object 204 and sink2 object 206.

Because event “/Account/90 Checking/Details/Friendly Name” is in-scope for both sink1 object 204 and sink2 object 206, the event “/Account/90 Checking/Details/Friendly Name” may be stored in queue 220 for sink1 object 204. and queue 222 for sink2 object 206 by EB.dll 212.

As another example, source1 object 208 may inject an event such as “/Account/00 Savings/Details/Friendly Name.” In this instance, only sink1 object 204 may be in-scope as determined by Eb.dll 212. Because event “/Account/00 Savings/Details/Friendly Name” is in-scope for sink1 object 204, the event “/Account/00 Savings/Details/Friendly Name” may be stored in queue 220 for sink1 object 204. Whether an event will be placed in a sink's queue will depend on the events that the particular sink has registered for as indicated by the hierarchical structure indicated in FIG. 2 for sink1 object 204 and sink2 object 206. As shown by arrow 224 located between sink1 object 204 and Accounts 216, sink1 object 204 may be registered for events for any Accounts 216. Similarly, as shown by arrow 226 located between sink2 object 206 and 90 Checking 218, sink2 object 206 may be registered for the events on the 90 Checking account 218 as opposed to the more-inclusive Accounts 216.

In addition to specifying the event scope for a certain sink, a subscriber may also specify various filters. The filters refer to properties in the event payload. For example, when registering sink1 object 204, Process1 202 might specify a filter such as EventType =“Balance Change.” This may limit the events delivered to sink1 to any balance change event on any of the accounts. Other filters may include an event type filter such as an enum value filter, a property ID filter, or a string comparison based filter.

Events may be delivered from sinks' event queues to their respective subscribers either synchronously or asynchronously through callbacks that are provided at sink registration. Each sink may be designated as either synchronous or asynchronous at the time of its registration.

In the synchronous case, pending events for synchronous sinks that registered on the current thread are dispatched through their respective callbacks. This may be completed on the same thread and before control returns to the caller.

Asynchronous sinks may be handled by a background thread spawned by the Event Broker system. Asynchronous sinks within the process may be lumped together. By default, sinks may be handled in the order they were registered. However, the order may be overridden by assigning priorities to the registered sinks.

An example of an application that may utilize the above described aspect of the present invention will now be discussed. In an application program such as Microsoft® Money, a database engine stores numerous transactions and details about those transactions. Examples of information that may be stored in the database include information about accounts, account balances, and payee information. In an application such as Microsoft® Money, it may be useful for a user interface component to register through a publish-subscribe system which utilizes a hierarchical namespace in order to receive notifications from other components. For example, a sink may want to know if a balance on an account changed. A source such as the database may inject events into the system and the EB.dll 212 may evaluate the events for a matching scope. Any event that has a matching scope may be placed in the sink's queue.

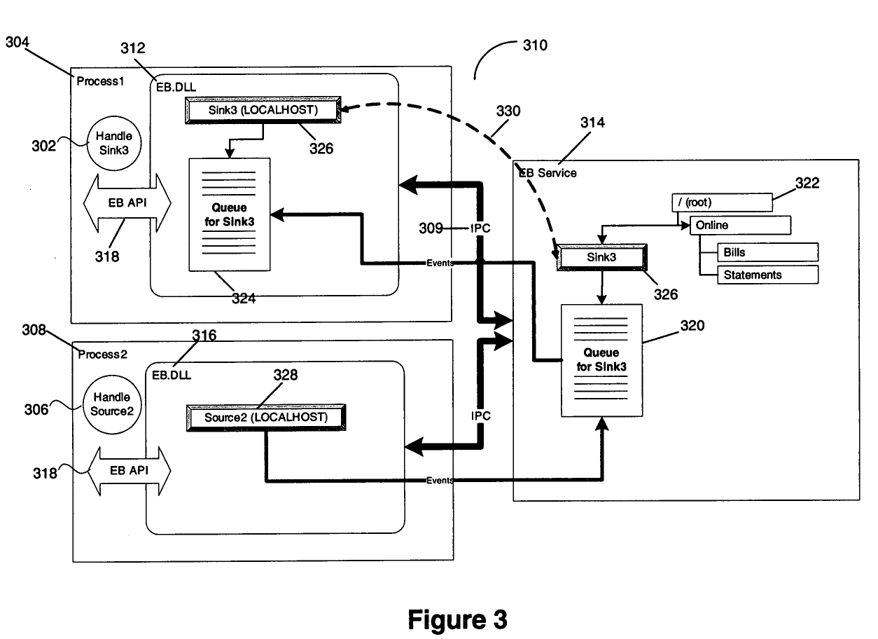

FIG. 3 illustrates a schematic diagram of an inter-process event notification system in accordance with another aspect of the present invention. In FIG. 3, a sink3 object 326 resides in a Process1 304 and a source2 object 328 resides in a Process2 308. Those skilled in the art will realize that additional sources and sinks may reside in either Process 1 304 or Process2 308, as only one source2 object 328 and sink3 object 326 were chosen for ease in illustrating certain aspects of the invention.

An Event Broker 310 may comprise components such as EB.dll 312, EB Service component 314, EB.dll 316, and EB common.dll (not shown). Process1 304 may communicate with EB.dll 312 through an application programming interface EB API 318. Similarly, Process2 308 may communicate with EB.dll 316 through application programming interface EB API 318. EB.dll 312 and EB.dll 316 may act as a proxy for out of process event queues. Objects such as sink3 object 302 and source2 object 306 may be handles used to identify objects within EB.dll 312 and EB.dll 316 during communication through an EB API 318.

EB API 318 may provide a single unified interface regardless of the location of the components. In addition, EB API 318 may include at least four sets of functions such as EB source functions, EB sink functions, EB general functions, and EB transaction functions. These functions may operate on a source object, a sink object, or an event.

EB Service 314 may manage event queues that are not in-process. For instance, EB Service 314 manages queue 320 for sink3 object 326. EB Service 314 receives events from the source2 object 328 through an inter-process communication (IPC) channel 309.

Process1 304 registers a sink3 object 326 on the event scope “LOCALHOST/Online”. This may result in a proxy sink “Sink3 (LOCALHOST)” 326 being created in EB.dll 312 which is running in Process1 304, but the actual sink3 object 326 is created in the EB Service 314.

Process2 308 may register source2 object 328 on the event scope “LOCALHOST/Online”. All events generated by source2 object 328 may be delivered to interested sinks' event queues in the EB Service 314. EB Service 314 determines which sinks may be interested in the injected events.

In FIG. 3, EB Service 314 compares the events to an internal data structure as indicated by hierarchy 322. EB service 314 may determine if sink3 object 326 is interested in the event injected by source2 object 328 by comparing the event's namespace to the internal data structure represented by hierarchy 322. If sink3 object 326 is interested in the injected event, then the event is placed in queue 320. When sink3 object 326 wants to retrieve the events located in queue 320, the events are routed to sink3 object's local queue 324 located in Process1 304. The sink3 object 326 located in Process1 304 is a proxy object or proxy sink for sink3 object 326 in EB Service 314. Dotted line 330 in FIG. 3 conveys the logical association between the in-process proxy sink 326 and the actual sink3 object 326 that exists in EB Service 314. The actual communication between these components may be routed through IPC channel 309. The communication between proxy objects and their respective sink and source objects in the EB Service 314 may be initiated periodically by the proxy objects.

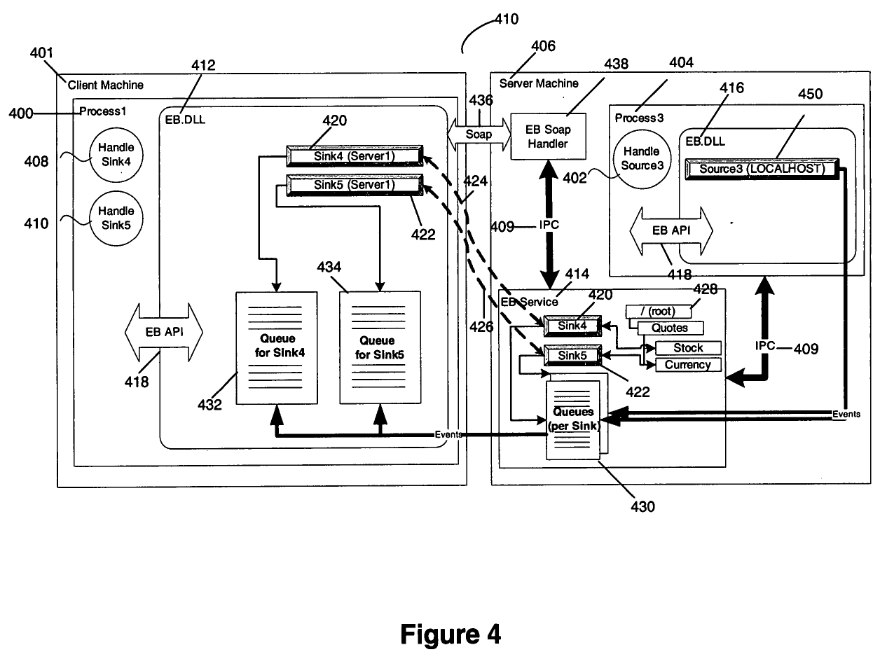

FIG. 4 shows a schematic diagram for a distributed event notification system in accordance with an aspect of the present invention. In FIG. 4, Process1 400 resides in a client machine 401. Process1 400 has registered within its domain sink4 object 420 and sink5 object 422. Sink4 object 420 and sink5 object 422 may be registered to receive particular events of interest.

A source3 object 450 resides in Process3 404 on a server machine 406. Those skilled in the art will realize that additional sources and sinks may reside on server machine 406 or on a client machine 401. Objects such as sink4 object 408, sink5 object 410, and source3 object 402 may be handles used to identify objects within EB.dll 412 or EB.dll 416 during communication through EB API 418.

An Event Broker 410 may comprise components such as a client-machine EB.dll 412, an EB Service component 414, a server-machine EB.dll 416, and EB common.dll (not shown). Process3 404 may communicate with server-machine EB.dll 416 through an application programming interface EB API 418. Similarly, Process1 400 may communicate with client-machine EB.dll 412 through application programming interface EB API 418.

The event queues for which sink4 object 420 and sinkS object 422 are registered may be managed by the EB Service 414 on server machine 406. Proxy objects for sink4 object 420 and Sink5 object 422 may be located in the Event Broker component EB.dll 412 of Process1 400 on the client machine 401.

EB Service 414 may receive events from source3 object 450 through an inter-process communication (IPC) channel 409. Process1 400 may register sink4 object 420 and sinkS object 422 for a particular event scope. This may result in a proxy sink “Sink4 (Server1)” 420 being created in EB.dll 412, which is running in Process1 400, but the actual sink4 object 420 is created in the EB Service 414. Similarly, for sink5 object 422, a proxy sink “Sink5 (Server1)” 422 may be created in EB.dll 412, but the actual sink5 object 422 is created in the EB Service 414. Dotted lines 424 and 426 in FIG. 4, convey logical associations between the in-process proxy sinks 420 and 422 and the actual sink4 object 420 and sink5 object 422 that exists in EB Service 414.

Events generated by source3 object 450 may be delivered to interested sinks' event queues in the EB Service 414. EB Service 414 determines which sinks may be interested in the injected events.

In FIG. 4, EB Service 414 compares the events to an internal data structure as indicated by hierarchy 428. EB service 414 may determine if sink4 object 420 or sink5 object 422 are interested in the event injected by source3 object 450 by comparing the event's namespace to the internal data structure represented by hierarchy 428. If sink4 object 420 or sink5 object 422 are interested in the injected event, then the event is placed in the sink's respective queue such as queues 430.

When sink4 object 420 or sink5 object 422 wants to retrieve the events located in queues 430, the events are routed to sinks local queues 432 or 434 located in Process1 400.

The communication between the client machine 401 and the server machine 406 may be accomplished over SOAP (Simple Object Access Protocol) 436 through a SOAP Handler 438 located on the server machine 406. For example, EB.dll 412 in Process1 400 may communicate through the use of SOAP 436 and SOAP handler 438. The SOAP Handler 438 translates the request from EB.dll 412 and forwards the request through IPC 409 to EB Service 414. In a LAN environment, DCOM may be used as an alternative to SOAP.

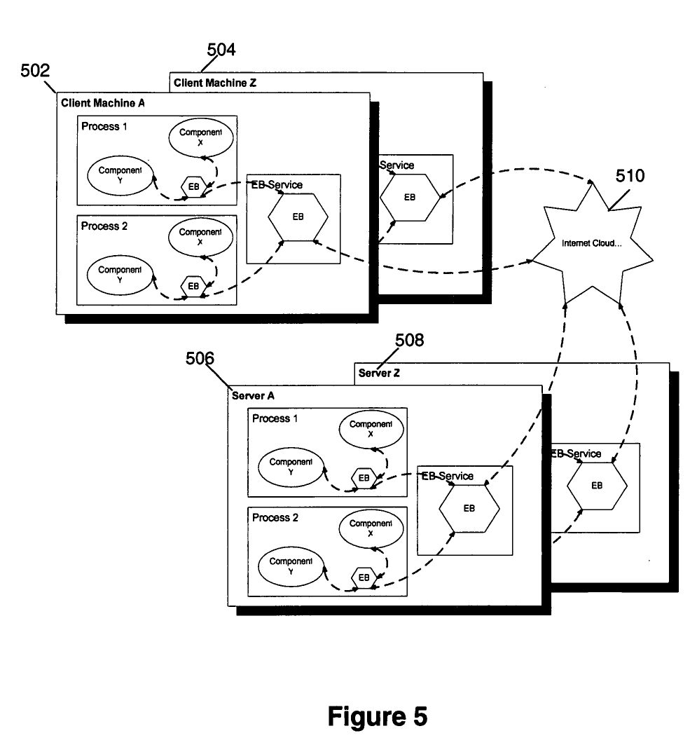

FIG. 5 illustrates another schematic diagram for a distributed event notification system in accordance with another aspect of the present invention. FIG. 5 shows that any number of client machines such as Client Machine A 502 and Client Machine Z 504 and servers such as Server A 506 and Server Z 508 may utilize the event notification system of the current invention over a distributed environment such as the Internet 510. Similar to the various aspects of the invention described above, the client machines and sever machines may include components of the event notification system in order to provide for in-process and inter-process event notification. The event notification system utilizes a hierarchical namespace to determine events of interest to registered subscribers. If an event falls within the hierarchical namespace of a registered subscriber, the event is received in the subscriber's queue.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

We claim:

1. A method of routing events of interest to a subscriber of events, the method comprising:
(a) specifying a hierarchical namespace to identify the events of interest to the subscriber;
(b) registering a sink with the specified hierarchical namespace;
(c) comparing names of the events to the hierarchical namespace of the registered sink; and
(d) if the names of the events fall within the specified hierarchal namespace of the registered sink, delivering the events to a sink queue.

2. The method of claim 1, wherein the hierarchical namespace comprises a tree structure.

3. The method of claim 1, further comprising:
(e) delivering the events from the sink queue to the subscriber synchronously.

4. The method of claim 3, wherein the synchronously delivered events are provided through callbacks at sink registration

5. The method of claim 1, further comprising:
(e) delivering the events from the sink queue to the subscriber asynchronously through callbacks provided at sink registration.

6. The method of claim 1, wherein the subscriber specifies a filter to further limit the events of interest to the subscriber.

7. The method of claim 6, wherein the filter comprises an event type filter, the event type including an enum value.

8. The method of claim 6, wherein the filter comprises a property ID filter.

9. The method of claim 6, wherein the filter comprises a string comparison based filter.

10. A computer-readable medium having computer-executable instructions for performing the method of claim 1.

11. A method of routing events to a subscriber in a networked environment, the method comprising:
(a) registering a sink with a specified hierarchical namespace through the networked environment;
(b) receiving events transmitted by a source through an inter-process communication channel;
(c) comparing names of the events to the specified hierarchical namespace of the registered sink; and
(d) if the names of the events fall within the specified hierarchal namespace of the registered sink, delivering the events to a sink queue.

12. The method of claim 11, wherein the hierarchical namespace comprises a tree structure.

13. The method of claim 11, further comprising:
(e) delivering the events from the sink queue to the subscriber synchronously.

14. The method of claim 13, wherein the synchronously delivered events are provided through callbacks at sink registration

15. The method of claim 11, further comprising:
(e) delivering the events from the sink queue to the subscriber asynchronously through callbacks provided at sink registration.

16. The method of claim 11, wherein the subscriber specifies a filter to further limit the events of interest to the subscriber.

17. The method of claim 16, wherein the filter comprises an event type filter, the event type including an enum value.

18. The method of claim 16, wherein the filter comprises a property ID filter.

19. The method of claim 16, wherein the filter comprises a string comparison based filter.

20. A computer-readable medium having computer-executable instructions for performing the method of claim 11.

21. The method of claim 11, wherein the comparison of names of the events to the specified hierarchical namespace of the registered sink further includes a wild card string comparison.

22. An event notification system for notifying a subscriber of event occurrences, the event notification system comprising:
(a) at least one source object for transmitting events;
(b) at least one sink object for receiving the transmitted events, the at least one sink object registering a hierarchical namespace to identify the events of interest to the subscriber; and
(c) event filtering components in communication with the at least one source object and the at least one sink object, the event filtering components capable of identifying the events of interest to the subscriber.

23. The system of claim 22, wherein the hierarchical namespace comprises a tree structure.

24. At least one computer readable medium containing computer-executable instructions that, when executed, route events to a subscriber in a networked environment, by performing steps comprising:
(a) registering a sink with a specified hierarchical namespace through the networked environment;
(b) receiving events transmitted by a source through an inter-process communication channel;
(c) comparing names of the events to the specified hierarchical namespace of the registered sink; and
(d) if the names of the events fall within the specified hierarchal namespace of the registered sink, delivering the events to a sink queue.

25. The computer readable medium of claim 24, wherein the hierarchical namespace comprises a tree structure.
